(19) United States
(12) Patent Application Publication
(10) Pub. No.: US 2025/0357643 A1
(43) Pub. Date: Nov. 20, 2025

(54) METHOD OF MANUFACTURING POWER STORAGE DEVICE

(71) Applicant: Prime Planet Energy & Solutions, Inc., Tokyo (JP)

(72) Inventor: Hideaki YAMANAKA, Kusatsu-shi (JP)

(21) Appl. No.: 19/019,464

(22) Filed: Jan. 14, 2025

(30) Foreign Application Priority Data
May 15, 2024 (JP) 2024-079644

(51) Int. Cl. H01M 50/536; H01M 50/30

(52) U.S. Cl. CPC H01M 50/536; H01M 50/30

(57) ABSTRACT

A method of manufacturing a power storage device includes a laser welding process of superposing an unwelded laminated current collector of an electrode body on an unwelded current collecting member, melting and mixing a first region of the unwelded laminated current collector and a second region of the unwelded current collecting member through irradiation with a laser beam, and forming a melted and solidified portion. The unwelded current collecting member has a gas exhaust channel, and the laser welding process includes melting the first region and the second region while exhausting gas to the outside through the gas exhaust channel, and forming the melted and solidified portion.

### CROSS-REFERENCE TO RELATED APPLICATIONS

This application is based upon and claims the benefit of priority from the prior Japanese Patent Application No. 2024-079644 filed on May 15, 2024, the entire contents of which are incorporated herein by reference.

### BACKGROUND

### Technical Field

The disclosure relates to a method of manufacturing a power storage device including an electrode body having a laminated current collector, and a current collecting member to which the laminated current collector of the electrode body is welded and which is conductively connected to the laminated current collector.

### Related Art

As a power storage device, a battery is known which includes an electrode body having positive and negative electrode sheets, and positive and negative current collecting members conductively connected to the electrode body. Specifically, in the case where the electrode body is of laminate type, for example, the electrode body has a plurality of positive electrode sheets and a plurality of negative electrode sheets, and each of the positive and negative electrode sheets has a foil current collector where an electrode foil of the electrode sheet is exposed. The electrode body has a laminated current collector of the positive electrode in which the foil current collectors where the electrode foils of the electrode sheets of the positive electrode are exposed are laminated, and a laminated current collector of the negative electrode in which the foil current collectors where the electrode foils of the electrode sheets of the negative electrode are exposed are laminated. On the other hand, in the case where the electrode body is of flat wound type, the electrode body has a strip-shaped positive electrode sheet and a strip-shaped negative electrode sheet, and each of the positive and negative electrode sheets has a strip-shaped foil current collector where an electrode foil of the electrode sheet is exposed. The electrode body has a laminated current collector of the positive electrode in which the foil current collector of the positive electrode sheet is wound into a flat shape such that layers of the foil current collector are laminated, and a laminated current collector of the negative electrode in which the foil current collector of the negative electrode sheet is wound into a flat shape such that layers of the foil current collector are laminated. Then, the laminated current collector of the positive electrode of the electrode body is welded to the current collecting member of the positive electrode, and the laminated current collector of the negative electrode of the electrode body is welded to the current collecting member of the negative electrode. Furthermore, in this type of battery, the current collecting member of the positive electrode is connected to a terminal of the positive electrode of the battery, and the current collecting member of the negative electrode is connected to a terminal of the negative electrode of the battery. Alternatively, the current collecting member of the positive electrode itself extends to the outside of the battery to provide the terminal of the positive electrode, and the current collecting member of the negative electrode itself extends to the outside of the battery to provide the terminal of the negative electrode.

In manufacturing the battery as described above, it is proposed to use laser welding to weld the laminated current collector of the electrode body and the current collecting member. Specifically, an unwelded laminated current collector before welding is superposed on an unwelded current collecting member before welding, and a laser beam is applied from above the unwelded laminated current collector to the unwelded laminated current collector, to melt and mix parts of the unwelded laminated current collector and the unwelded current collecting member. The melted part, i.e., the metal into which a part of the unwelded laminated current collector and a part of the unwelded current collecting member are melted and mixed, is then solidified to form a melted and solidified portion. In this manner, the laminated current collector is welded to the current collecting member. Related prior art documents include, for example, Japanese unexamined patent application publication No. 2019-067570 (JP 2019-067570 A).

### SUMMARY

### Technical Problems

However, it has been found that large or many blowholes are generated in the melted and solidified portion formed by welding. During laser welding, gas, such as air, remains between foil current collectors that form a first region to be melted with the laser beam, of the unwelded laminated current collector, and between the first region and a second region of the unwelded current collecting member that overlaps the first region. Therefore, it is considered that the gas becomes trapped in the melted and solidified portion during laser welding, and turns into blowholes.

The disclosure was made in view of the situation as described above, and provides a method of manufacturing a power storage device that can reduce or eliminate blowholes generated in a melted and solidified portion when an unwelded laminated current collector of an electrode body is laser-welded to an unwelded current collecting member.

### Means of Solving the Problems

(1) One aspect of the disclosure for solving the above problem is a method of manufacturing a power storage device including an electrode body having an electrode sheet including an electrode foil, the electrode body having a laminated current collector in which foil current collectors where the electrode foil of the electrode sheet is exposed are laminated in a lamination direction, the power storage device further including a current collecting member to which the laminated current collector of the electrode body is welded and which is conductively connected to the laminated current collector. The method includes a laser welding process of superposing an unwelded laminated current collector before welding on an unwelded current collecting member before welding in the lamination direction, melting and mixing a first region of the unwelded laminated current collector and a second region of the unwelded current collecting member that overlaps the first region through irradiation with a laser beam, and then solidifying a metal into which the first region and the second region are melted and mixed to form a melted and solidified portion and weld the laminated current collector to the current collecting member. In the method, the unwelded current collecting member has a gas exhaust channel at least in the second region, and the laser welding process includes melting the first region and the second region while exhausting gas generated from the first region and the second region to an outside through the gas exhaust channel, and then forming the melted and solidified portion.

In the method of manufacturing the power storage device described above, the gas exhaust channel, such as a groove or a through-hole, is provided in advance at least in the second region to be melted during welding, as part of the unwelded current collecting member before welding. Then, in the laser welding process, the first region of the unwelded laminated current collector and the second region of the unwelded current collecting member are melted, and, after gas generated from these regions is exhausted from the gas exhaust channel to the outside, the melted and solidified portion is formed. Therefore, blowholes are less likely or unlikely to be generated in the melted and solidified portion.

Examples of the “power storage device” include secondary batteries, such as a lithium-ion secondary battery, sodium-ion secondary battery, and a calcium-ion secondary battery, and capacitors, such as a lithium-ion capacitor.

Examples of the “gas exhaust channel” include an overlapping surface side gas exhaust groove provided in an overlapping surface of the unwelded current collecting member on which the laminated current collector is superposed, a rear surface side gas exhaust groove provided in a rear surface of the unwelded current collecting member opposite to the overlapping surface, a gas exhaust through-hole that penetrates the unwelded current collecting member between the overlapping surface and the rear surface, and so forth, as described below. The overlapping surface side gas exhaust groove will be described in a first embodiment (see FIG. 7, FIG. 8, etc.), second embodiment (see FIG. 11 and FIG. 12), and a sixth embodiment (see FIG. 19 and FIG. 20), and the rear surface side gas exhaust groove will be described in a third embodiment (see FIG. 13 and FIG. 14), while the gas exhaust through-hole will be described in a fourth embodiment (see FIG. 15 and FIG. 16) and a fifth embodiment (see FIG. 17 and FIG. 18). A part of the gas exhaust channel may remain in the current collecting member after laser welding, as described below in the first to sixth embodiments, or the gas exhaust channel may not be present in the current collecting member after laser welding due to the formation of the melted and solidified portion by laser welding, as described below in a modified embodiment (see FIG. 10) of the first embodiment.

The power storage device is not limited to the type in which only the two components, i.e., the laminated current collector and the current collecting member, are laser-welded together, but may further include another metal member that cooperates with the current collecting member to sandwich the laminated current collector of the electrode body in the lamination direction, and is welded to the laminated current collector and the current collecting member. In this case, in the laser welding process, an unwelded metal member before welding is further superposed on the unwelded laminated current collector superposed on the unwelded current collecting member (that is, the unwelded laminated current collector is sandwiched between the unwelded current collecting member and the unwelded metal member), and the metal member, the laminated current collector, and the current collecting member are laser-welded together.

(2) In the method of manufacturing the power storage device described in (1) above, the unwelded current collecting member may have an overlapping surface on which the unwelded laminated current collector is superposed, and the gas exhaust channel may be an overlapping surface side gas exhaust groove provided in the overlapping surface of the unwelded current collecting member and provided at least in the second region.

In the method of manufacturing the power storage device described above, the unwelded current collecting member has, as the gas exhaust channel, the overlapping surface side gas exhaust groove provided in a portion on the overlapping surface side of the unwelded current collecting member and provided at least in the second region. Therefore, in the laser welding process, the gas can be properly exhausted from the overlapping surface side gas exhaust groove, and the melted and solidified portion with no blowholes or reduced blowholes can be formed.

(3) In the method of manufacturing the power storage device described in (2) above, the overlapping surface side gas exhaust groove may have a shape of an inversely tapered groove of which the width increases from the overlapping surface of the unwelded current collecting member toward a bottom of the overlapping surface side gas exhaust groove, and the second region of the unwelded current collecting member may include at least overlapping surface side portions on the overlapping surface side of a pair of side walls that defines the overlapping surface side gas exhaust groove.

In the method of manufacturing the power storage device described above, the overlapping surface side gas exhaust groove has the shape of inversely tapered groove, and at least the overlapping surface side portions of the pair of side walls that defines the overlapping surface side gas exhaust groove, as part of the unwelded current collecting member, is melted as the second region. Therefore, compared to the case where the groove has the tapered groove shape and tapers from the overlapping surface toward the bottom, or the case where the groove width does not change in the depth direction, the volume of the second region, and consequently the volume of the melted and solidified portion, are increased, and the current collecting member and the laminated current collector can be reliably welded together. In the meantime, the overlapping surface side gas exhaust groove is the inversely tapered groove that is wider on the bottom side; therefore, the generated gas is easily exhausted to the outside through the overlapping surface side gas exhaust groove, and the possibility of generation of blowholes in the melted and solidified portion can be effectively reduced or eliminated.

(4) In the method of manufacturing the power storage device described in (1) above, the unwelded current collecting member may have an overlapping surface on which the unwelded laminated current collector is superposed, and a rear surface located opposite to the overlapping surface, and the gas exhaust channel may be a rear surface side gas exhaust groove provided in the rear surface of the unwelded current collecting member and provided at least in the second region.

In the method of manufacturing the power storage device described above, the unwelded current collecting member has, as the gas exhaust channel, the rear surface side gas exhaust groove provided in a portion on the rear surface side of the unwelded current collecting member and provided at least in the second region. Therefore, in the laser welding process, the gas is properly exhausted from the rear surface side gas exhaust groove, and the melted and solidified portion with no blowholes or reduced blowholes can be formed.

(5) In the method of manufacturing the power storage device described in (1) above, the unwelded current collecting member may have an overlapping surface on which the unwelded laminated current collector is superposed, and a rear surface located opposite to the overlapping surface, and the gas exhaust channel may be a gas exhaust through-hole that penetrates the unwelded current collecting member between the overlapping surface and the rear surface and is provided at least in the second region.

In the method of manufacturing the power storage device described above, the unwelded current collecting member has, as the gas exhaust channel, the gas exhaust through-hole that penetrates the unwelded current collecting member and is provided at least in the second region. Therefore, in the laser welding process, the gas is properly exhausted from the gas exhaust through-hole, and the melted and solidified portion with no blowholes or reduced blowholes can be formed.

Examples of the “gas exhaust through-hole” include through-holes with cross-sections perpendicular to the depth direction of the through-hole having circular, oval, elliptical, rectangular, polygonal, and other shapes. The gas exhaust through-hole may be a through-hole (e.g., a cylindrical through-hole) of which the shape or size of the cross-section does not change in the depth direction, or a through-hole (e.g., a tapered through-hole that tapers toward the rear surface side or an inversely tapered through-hole that widens toward the rear surface side) of which the size or shape of the cross-section changes in the depth direction.

(6) In the method of manufacturing the power storage device described in (5) above, the gas exhaust through-hole may have an inversely tapered shape in which a size increases from the overlapping surface of the unwelded current collecting member toward the rear surface, and the second region of the unwelded current collecting member may include at least an overlapping surface side portion on the overlapping surface side of an inner wall that defines the gas exhaust through-hole.

In the method of manufacturing the power storage device described above, the gas exhaust through-hole has the inversely tapered shape and widens toward the rear surface side, and at least the overlapping surface side portion of the inner wall that defines the gas exhaust through-hole, as part of the unwelded current collecting member, is melted as the second region. Therefore, compared to the case where the through-hole has a tapered shape and tapers from the overlapping surface toward the rear surface or the case where the dimension of the through-hole does not change in the depth direction, the volume of the second region, and consequently the volume of the melted and solidified portion, is increased, and the current collecting member and the laminated current collector can be reliably welded together. In the meantime, since the gas exhaust through-hole has the inversely tapered shape and is wider on the rear surface side, the generated gas is easily exhausted to the outside through the gas exhaust through-hole, and the possibility of generation of blowholes in the melted and solidified portion can be effectively reduced or eliminated.

### BRIEF DESCRIPTION OF THE DRAWINGS

FIG. 1 is a perspective view of a battery according to a first embodiment;

FIG. 2 is a partial cross-sectional view of the battery according to the first embodiment, taken along the battery height direction and the battery width direction;

FIG. 3 is a cross-sectional view of the battery according to the first embodiment as seen in the direction of arrows in FIG. 2, taken along the battery height direction and the battery thickness direction;

FIG. 4 is a flowchart of a method of manufacturing the battery according to the first embodiment;

FIG. 5 is an explanatory view as seen from above, showing an unwelded laminated current collector of an electrode body superposed on an unwelded current collecting member and pressing jigs further superposed on the unwelded laminated current collector, in connection with the method of manufacturing the battery according to the first embodiment;

FIG. 6 is a cross-sectional view as seen in the direction of arrows in FIG. 5, showing the unwelded laminated current collector of the electrode body superposed on the unwelded current collecting member and the pressing jigs further superposed on the unwelded laminated current collector, in connection with the method of manufacturing the battery according to the first embodiment;

FIG. 7 is an explanatory view showing the manner of applying a laser beam to the unwelded laminated current collector while pressing the unwelded laminated current collector against the unwelded current collecting member, in connection with the method of manufacturing the battery according to the first embodiment;

FIG. 8 is an explanatory view showing a melted and solidified portion formed by laser welding, in connection with the method of manufacturing the battery according to the first embodiment;

FIG. 9 is an explanatory view showing positive and negative laminated current collectors of the electrode body connected to positive and negative current collecting members, in connection with the method of manufacturing the battery according to the first embodiment;

FIG. 10 is an explanatory view showing the melted and solidified portion formed by laser welding, in connection with the method of manufacturing the battery according to a modified embodiment of the first embodiment;

FIG. 11 is an explanatory view showing the manner of applying a laser beam to an unwelded laminated current collector while pressing the unwelded laminated current collector against an unwelded current collecting member, in connection with a method of manufacturing a battery according to a second embodiment;

FIG. 12 is an explanatory view showing a melted and solidified portion formed by laser welding, in connection with the method of manufacturing the battery according to the second embodiment;

FIG. 13 is an explanatory view showing the manner of applying a laser beam to an unwelded laminated current collector while pressing the unwelded laminated current collector against an unwelded current collecting member, in connection with a method of manufacturing a battery according to a third embodiment;

FIG. 14 is an explanatory view showing a melted and solidified portion formed by laser welding, in connection with the method of manufacturing the battery according to the third embodiment;

FIG. 15 is an explanatory view showing the manner of applying a laser beam to an unwelded laminated current collector while pressing the unwelded laminated current collector against an unwelded current collecting member, in connection with a method of manufacturing a battery according to a fourth embodiment;

FIG. 16 is an explanatory view showing a melted and solidified portion formed by laser welding, in connection with the method of manufacturing the battery according to the fourth embodiment;

FIG. 17 is an explanatory view showing the manner of applying a laser beam to an unwelded laminated current collector while pressing the unwelded laminated current collector against an unwelded current collecting member, in connection with a method of manufacturing a battery according to a fifth embodiment;

FIG. 18 is an explanatory view showing a melted and solidified portion formed by laser welding, in connection with the method of manufacturing the battery according to the fifth embodiment;

FIG. 19 is an explanatory view showing the manner of applying a laser beam to an unwelded metal member while pressing an unwelded laminated current collector against an unwelded current collecting member, in connection with a method of manufacturing a battery according to a sixth embodiment; and

FIG. 20 is an explanatory view showing a melted and solidified portion formed by laser welding, in connection with the method of manufacturing the battery according to the sixth embodiment;

### DETAILED DESCRIPTION OF THE EXEMPLARY EMBODIMENTS

### First Embodiment

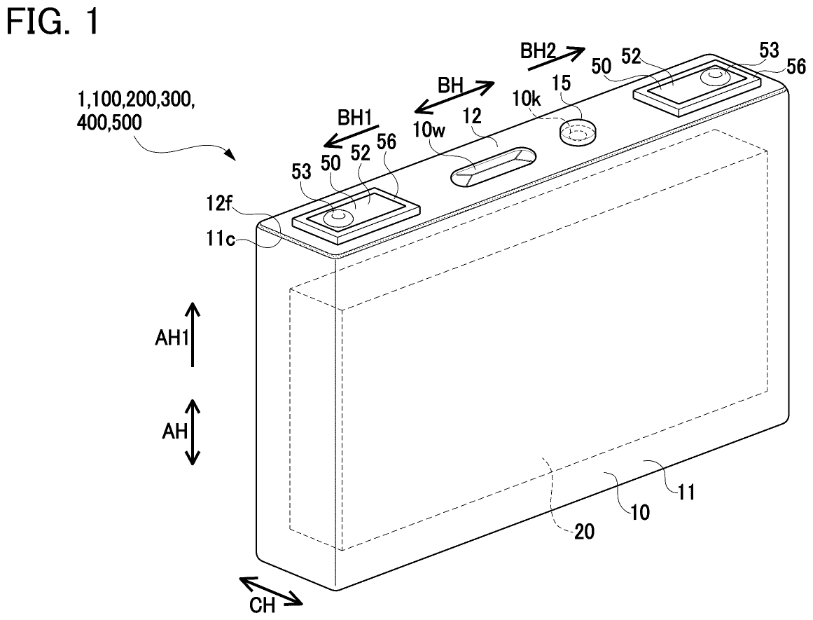

In the following, the first embodiment of the disclosure will be described with reference to the drawings. In the following description, the battery height direction AH, battery width direction BH, and battery thickness direction CH of a battery 1 (one example of the power storage device of the disclosure) 1 are defined as the directions indicated in FIG. 1 to FIG. 3. The battery 1 is a sealed lithium-ion secondary battery of a rectangular (rectangular parallelepiped) shape, which is installed on a vehicle, such as a hybrid vehicle, plug-in hybrid vehicle, or an electric vehicle. The battery 1 consists of a case 10, an electrode body 20 and electrolyte 5 housed in the case 10, positive and negative terminals 50 respectively supported by the case 10, and so forth (see FIG. 1 to FIG. 3). A laminated current collector 30 of the positive electrode of the electrode body 20 is connected to the terminal 50 of the positive electrode via a current collecting member 40 of the positive electrode, and the laminated current collector 30 of the negative electrode of the electrode body 20 is connected to the terminal 50 of the negative electrode via the current collecting member 40 of the negative electrode. In the case 10, the electrode body 20 is covered with a bag-shaped insulating holder 7 formed from an insulating film.

The case 10 is shaped like a rectangular parallelepiped box and made of metal (aluminum in the first embodiment). The case 10 consists of a case body 11 and a case lid member 12. The case body 11 is in the form of a rectangular tube with a bottom and a rectangular opening portion 11c and houses the electrode body 20 therein. The case lid member 12 is in the form of a rectangular plate that closes the opening portion 11c of the case body 11. The opening portion 11c of the case body 11 and a peripheral portion 12f of the case lid member 12 are hermetically welded together over the entire circumference thereof. The case lid member 12 is provided with a safety valve 10w that fractures and opens when the internal pressure of the case 10 exceeds the valve opening pressure. The case lid member 21 is also provided with a liquid inlet 10k, and the liquid inlet 10k is hermetically sealed with a disc-shaped sealing member 15 made of aluminum.

Insertion holes 10h are respectively provided in portions of the case lid member 12 near its ends on one side BH1 and the other side BH2 in the battery width direction BH. The terminal 50 of the positive electrode made of aluminum is inserted through the insertion hole 10h on the one side BH1, and the terminal 50 of the negative electrode made of copper is inserted through the insertion hole 10h on the other side BH2. Since the positive and negative terminals 50 have substantially the same configuration, the same reference numeral is assigned to the terminals 50, which will be described collectively below. The terminal 50 is fixed to the case lid member 12 via an internal insulating member 55 placed inside the case 10 and an external insulating member 56 mainly placed outside the case 10.

The terminal 50 consists of an internal terminal member 51, an external terminal member 52, and a crimped terminal member 53. The internal terminal member 51 is in the form of a rectangular plate extending in the battery width direction BH and the battery thickness direction CH, and is located inside the case 10. The external terminal member 52 is in the form of a rectangular plate extending in the battery width direction BH and the battery thickness direction CH, and is located outside the case 10. The crimped terminal member 53 is inserted through the insertion hole 10h, and further extends through the internal terminal member 51 and the external terminal member 52, to be crimped and connected to the internal terminal member 51 and the external terminal member 52. The current collecting member 40 of the positive electrode that will be described below is welded to the internal terminal member 51 of the terminal 50 of the positive electrode, and the current collecting member 40 of the negative electrode is welded to the internal terminal member 51 of the terminal 50 of the negative electrode.

Next, the electrode body 20 will be described. The electrode body 20 is of a rectangular parallelepiped, laminate type, and has a plurality of electrode sheets 21 of the positive electrode and a plurality of electrode sheets 21 of the negative electrode alternately laminated via separators 24 in the form of porous resin films. Each of the positive and negative electrode sheets 21 and the separators 24 has a rectangular shape extending in the battery height direction AH and the battery width direction BH. Since the positive and negative electrode sheets 21 have substantially the same configuration, the same reference numeral is assigned to the electrode sheets 21, which will be collectively described below.

The electrode sheet 21 consists of a rectangular electrode foil 22 (aluminum foil for the positive electrode and copper foil for the negative electrode), and active material layers 23 including active material particles and respectively formed on both main surfaces of the electrode foil 22. A part of the electrode foil 22 extends to the upper side AH1 in the battery height direction AH. The extended part of the electrode foil 22 is exposed without the active material layers 23 present on both of its main surfaces, and provides a foil current collector 21r of the electrode sheet 21. The portions of the respective electrode sheets 21 that have the active material layers 23 on the electrode foils 22 are laminated via separators 24, to form a main body 25 of the electrode body 20. On the other hand, the foil current collectors 21r of the respective electrode sheets 21 are laminated in a lamination direction SH, to form a laminated current collector 30 that connects to the main body 25 of the electrode body 20. The laminated current collector 30 of the positive electrode is welded at its distal end portion to the current collecting member 40 of the positive electrode, and is conductively connected to the current collecting member 40. The laminated current collector 30 of the negative electrode is welded at its distal end portion to the current collecting member 40 of the negative electrode, and is conductively connected to the current collecting member 40.

The current collecting member 40 of the positive electrode is made of aluminum, and the current collecting member 40 of the negative electrode is made of copper. Since the positive and negative current collecting members 40 have substantially the same configuration, the same reference numeral is assigned to the current collecting members 40, which will be collectively described below. The current collecting member 40 is in the form of a rectangular plate extending in the battery width direction BH and the battery thickness direction CH. The current collecting member 40 of the positive electrode is welded at its end portion on one side BH1 in the battery width direction BH to the internal terminal member 51 of the terminal 50 of the positive electrode, and is conductively connected to the terminal 50 of the positive electrode. On the other hand, the current collecting member 40 of the negative electrode is welded at its end portion on the other side BH2 in the battery width direction BH to the internal terminal member 51 of the terminal 50 of the negative electrode, and is conductively connected to the terminal 50 of the negative electrode.

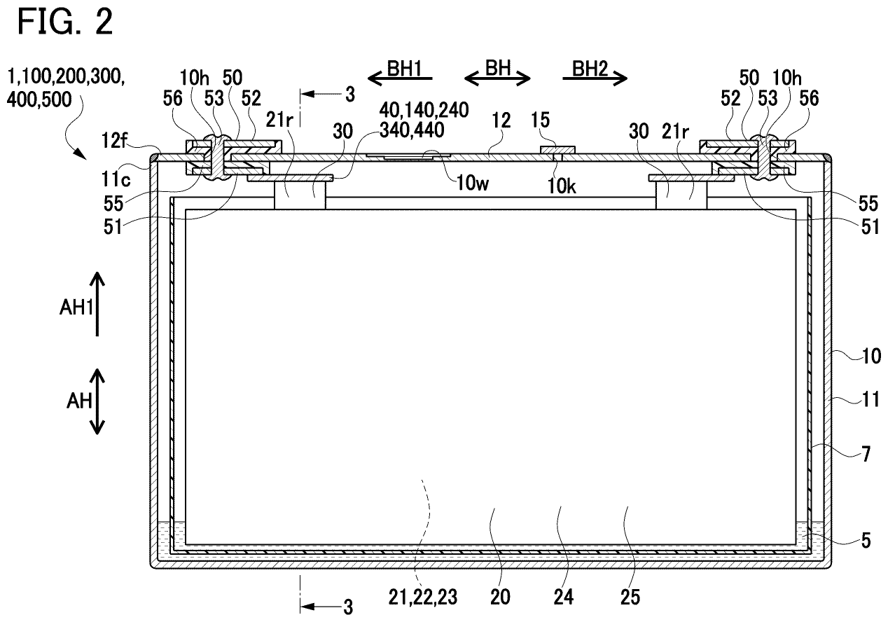

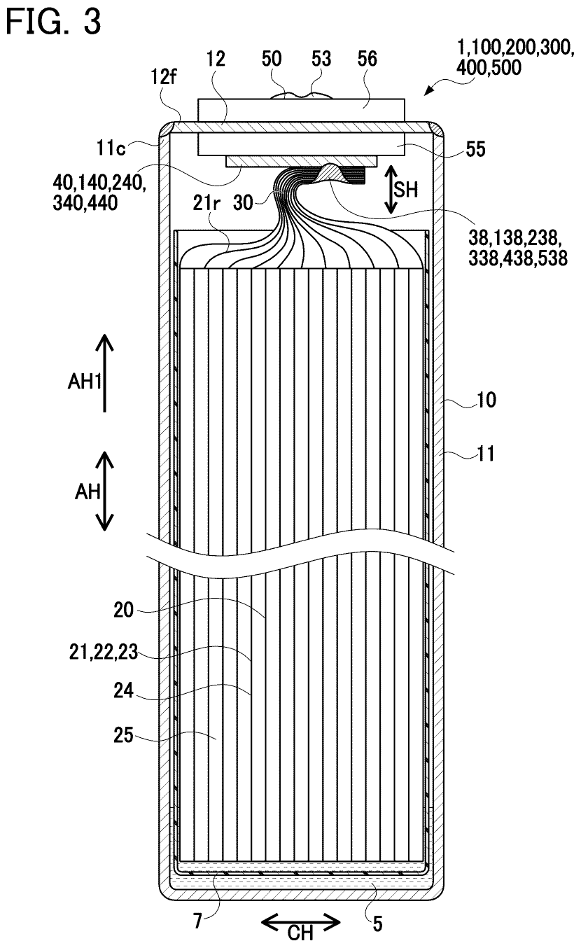

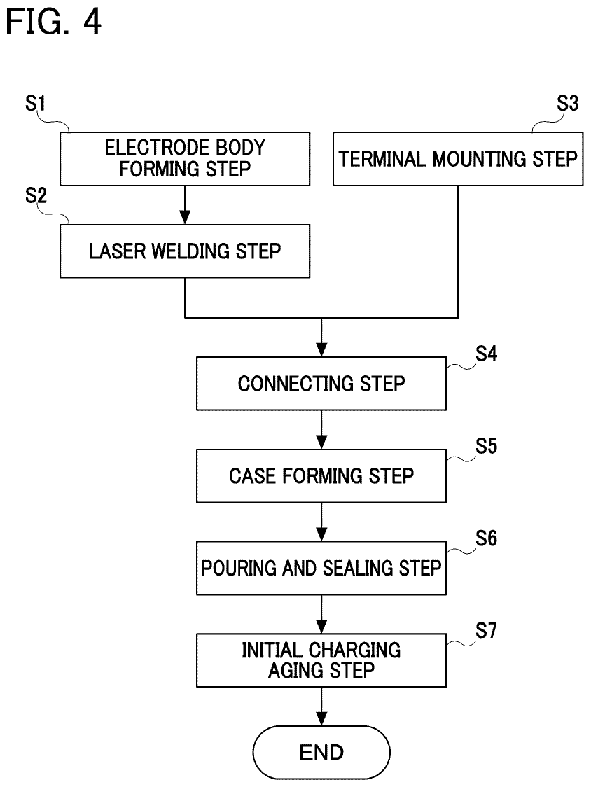

Next, a method of manufacturing the battery 1 described above will be described (see FIG. 4 to FIG. 9). First, in an electrode body forming step S1 (see FIG. 4), the electrode body 20 is formed. Specifically, a plurality of electrode sheets 21 of the positive electrode, a plurality of electrode sheets 21 of the negative electrode, and a plurality of separators 24, each having a rectangular shape, are prepared. Then, the electrode sheets 21 of the positive electrode and the electrode sheets 21 of the negative electrode are alternately laminated with the separators 24 sandwiched between the positive and negative electrode sheets 21, to form the electrode body 20 (see FIG. 2 and FIG. 3).

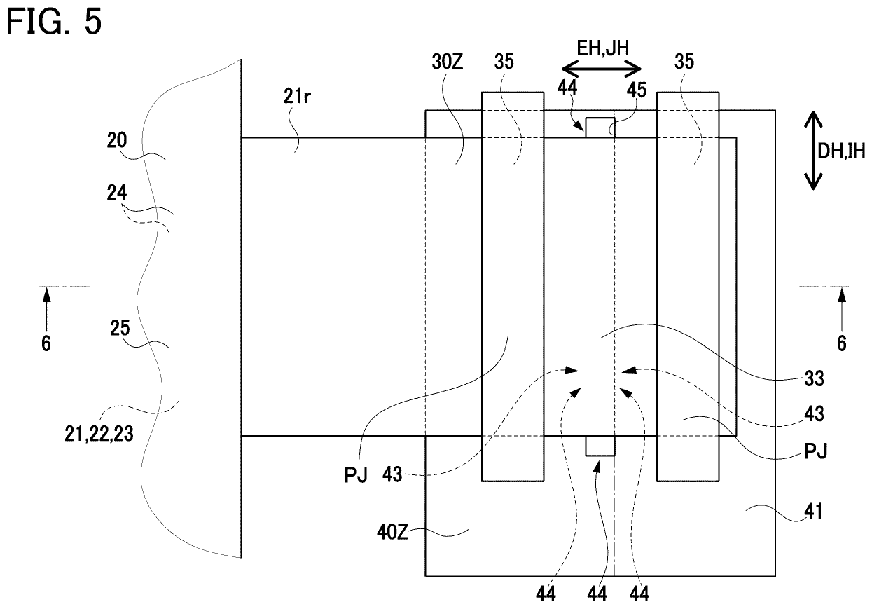

Next, in a laser welding step S2 (see FIG. 4), unwelded current collecting members 40Z of the positive and negative electrodes before welding are prepared, and an unwelded laminated current collector 30Z of the positive electrode before welding as part of the electrode body 20 is laser-welded to the unwelded current collecting member 40Z of the positive electrode, while an unwelded laminated current collector 30Z of the negative electrode before welding as part of the electrode body 20 is laser-welded to the unwelded current collecting member 40Z of the negative electrode (see FIG. 5 to FIG. 9).

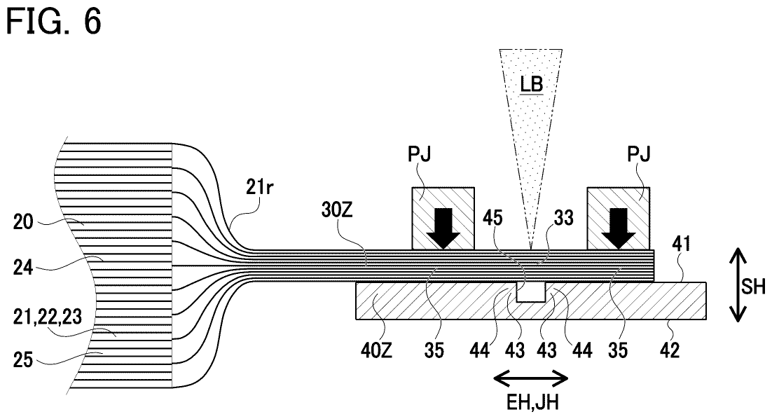

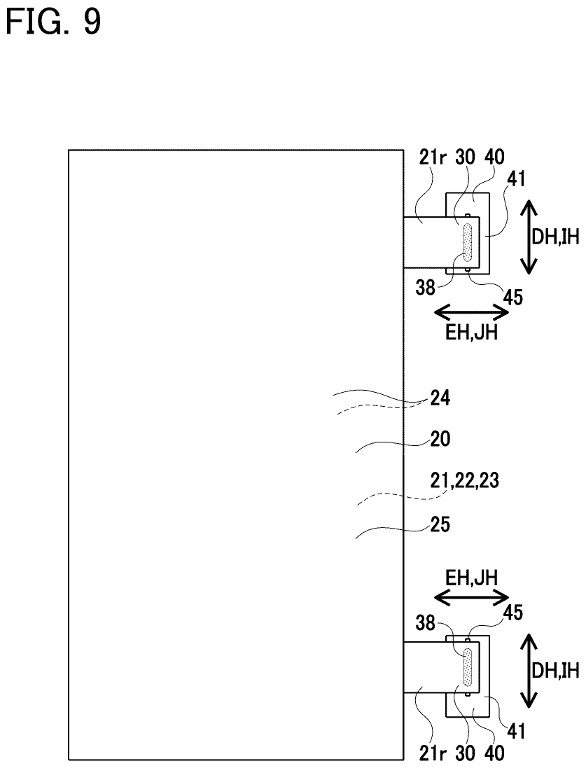

The unwelded laminated current collector 30Z of the electrode body 20 is in the form of a rectangular plate that extends in an extension direction JH (the lateral direction in FIG. 5 to FIG. 9) from the main body 25 of the electrode body 20. In the first embodiment, the thickness of the unwelded laminated current collector 30Z when pressed in the lamination direction SH is 1.0 mm. In the first embodiment, a first region 33 to be melted by laser welding, of the unwelded laminated current collector 30Z, extends in an orthogonal direction IH (the vertical direction in FIG. 5 and FIG. 9, the direction perpendicular to the plane of paper in FIG. 6 to FIG. 8) that is orthogonal to the extension direction JH in a distal end portion of the unwelded laminated current collector 30Z, and extends over the entire thickness in the lamination direction SH.

The unwelded current collecting member 40Z is in the form of a rectangular plate extending in a first direction DH (the vertical direction in FIG. 5 and FIG. 9, the direction perpendicular to the plane of paper in FIG. 6 to FIG. 8) and a second direction EH (the lateral direction in FIG. 5 to FIG. 9) perpendicular to the first direction DH. The unwelded current collecting member 40Z has a flat overlapping surface 41 on which the unwelded laminated current collector 30Z is superposed during welding, and a flat rear surface 42 that is parallel to the overlapping surface 41 and is located opposite to the overlapping surface 41. In the first embodiment, the thickness of the unwelded current collecting member 40Z is 1.0 mm. In the first embodiment, in a condition where the unwelded laminated current collector 30Z is superposed on the unwelded current collecting member 40Z, the first direction DH of the unwelded current collecting member 40Z is the same as the orthogonal direction IH of the unwelded laminated current collector 30Z, and the second direction EH of the unwelded current collecting member 40Z is the same as the extension direction JH of the unwelded laminated current collector 30Z.

The unwelded current collecting member 40Z has a gas exhaust channel 45 at least in a second region 43 to be melted by laser welding. In the first embodiment, the gas exhaust channel 45 is formed in an exhaust channel forming region 44 including the second region 43. In the first embodiment, the second region 43 is a region of the unwelded current collecting member 40Z that overlaps the first region 33 of the unwelded laminated current collector 30Z, and is located on the overlapping surface 41 side, extending in the first direction DH in a middle portion as viewed in the second direction EH. The exhaust channel forming region 44 includes the entire second region 43, and further extends from the second region 43 to the opposite sides in the first direction DH.

The gas exhaust channel 45, which is provided in the exhaust channel forming region 44, is an overlapping surface side gas exhaust groove that is provided on the overlapping surface 41 side of the unwelded current collecting member 40Z and extends in the first direction DH. Specifically, a longitudinally middle portion of the overlapping surface side gas exhaust groove 45 is provided in a portion of the exhaust channel forming region 44 located in the second region 43 and its rear surface 42 side, and longitudinally opposite end portions of the overlapping surface side gas exhaust groove 45 are provided in portions of the exhaust channel forming region 44 that are not in the second region 43 and extend beyond the second region 43 to the opposite sides in the first direction DH.

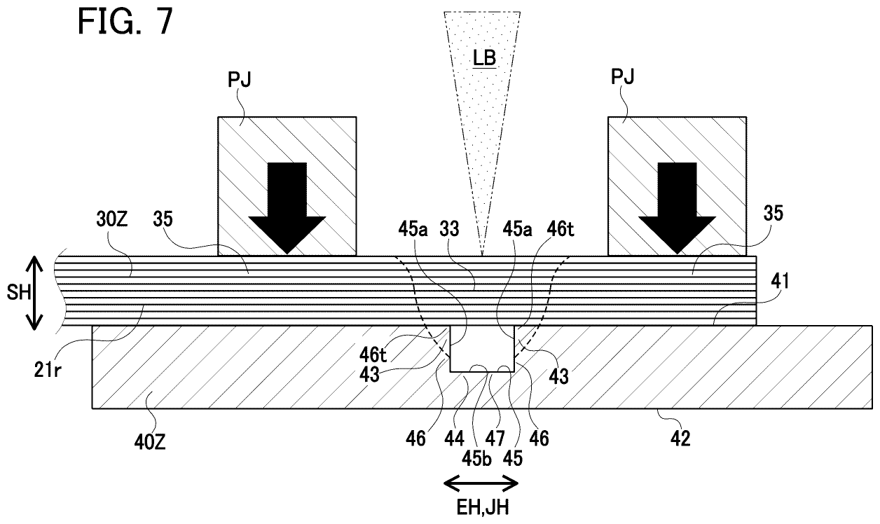

The overlapping surface side gas exhaust groove 45 has a bottom 45b parallel to the overlapping surface 41 and rear surface 42 of the unwelded current collecting member 40Z, and a pair of sides 45a extending from the bottom 45b to the overlapping surface 41. The groove width of the overlapping surface side gas exhaust groove 45 is constant from the bottom 45b to the overlapping surface 41 (i.e., the groove width does not change in the depth direction) (see FIG. 7). In the first embodiment, the dimensions of the overlapping surface side gas exhaust groove 45 are 0.6 mm in width (dimension in the second direction EH), 0.4 mm in depth, and 5.0 mm in length (dimension in the first direction DH).

In the first embodiment, the overlapping surface side gas exhaust groove 45 is provided in a part of the unwelded current collecting member 40Z as viewed in the first direction DH. However, the overlapping surface side gas exhaust groove 45 may be provided over the entire length of the unwelded current collecting member 40Z in the first direction DH, that is, may extend from one end to the other end in the first direction DH of the unwelded current collecting member 40Z, as indicated by dash-dotted lines in FIG. 5.

Initially, in the laser welding step S2, the unwelded laminated current collector 30Z is superposed on the overlapping surface 41 of the unwelded current collecting member 40Z in the lamination direction SH (see FIG. 5 to FIG. 7). A pair of pressing jigs PJ is further superposed on the unwelded laminated current collector 30Z, and the unwelded laminated current collector 30Z is pressed downward against the unwelded current collecting member 40Z with the pressing jigs PJ. The pressing jigs PJ, each having a rectangular parallelepiped shape, press both outer portions 35 of the unwelded laminated current collector 30Z that are located outside the first region 33 in the extension direction JH while avoiding the first region 33 of the unwelded laminated current collector 30Z.

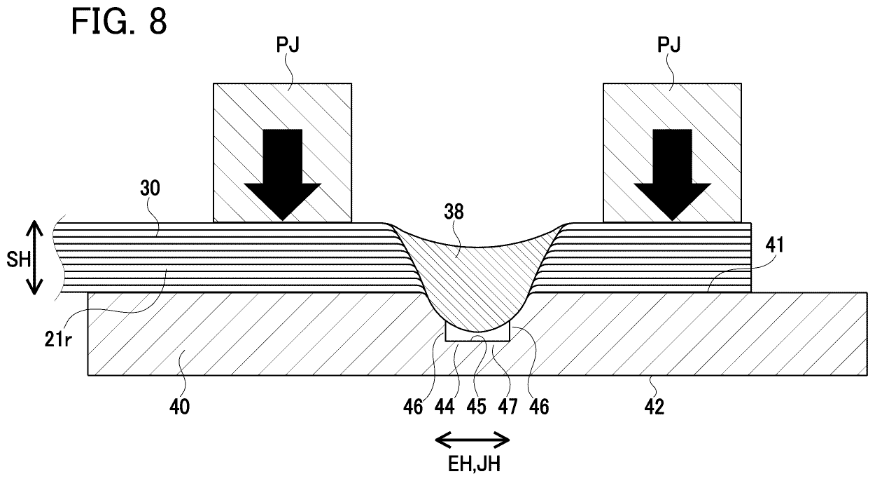

Subsequently, a laser beam LB is applied from above to the first region 33 of the unwelded laminated current collector 30Z, to melt and mix the first region 33 and the second region 43 of the unwelded current collecting member 40Z that overlaps the first region 33. The metal into which the first region 33 and the second region 43 are melted and mixed is then solidified to form a melted and solidified portion 38 so that the laminated current collector 30 is welded to the current collecting member 40 (see FIG. 8 and FIG. 9). In the first embodiment, YAG laser is used. The dimensions of the melted and solidified portion 38 are 2.0 mm in width (dimension in the extension direction JH and the second direction EH) and 4.0 mm in length (dimension in the orthogonal direction IH and the first direction DH).

In the laser welding, the first region 33 of the unwelded laminated current collector 30Z and the second region 43 of the unwelded current collecting member 40Z are melted, and gas generated from the first and second regions 33, 43 is exhausted to the outside through the overlapping surface side gas exhaust groove 45. Then, the melted and solidified portion 38 is formed. Therefore, blowholes are less likely or unlikely to be generated in the melted and solidified portion 38. Since the overlapping surface side gas exhaust groove 45 extends in the first direction DH, the gas is exhausted to the outside from the opposite sides of the overlapping surface side gas exhaust groove 45 in the first direction DH.

In the first embodiment, the second region 43 of the unwelded current collecting member 40Z comprises overlapping surface side portions 46t on the overlapping surface 41 side of both side walls 46 that define both of the sides 45a of the overlapping surface side gas exhaust groove 45, as part of the unwelded current collecting member 40Z. Portions on the rear surface 42 side of the both side walls 46 of the unwelded current collecting member 40Z and a bottom portion 47 of the unwelded current collecting member 40Z that defines the bottom 45b of the overlapping surface side gas exhaust groove 45 remain without being melted after welding, and a part of the overlapping surface side gas exhaust groove 45 on the bottom 45b side remains after welding (FIG. 8).

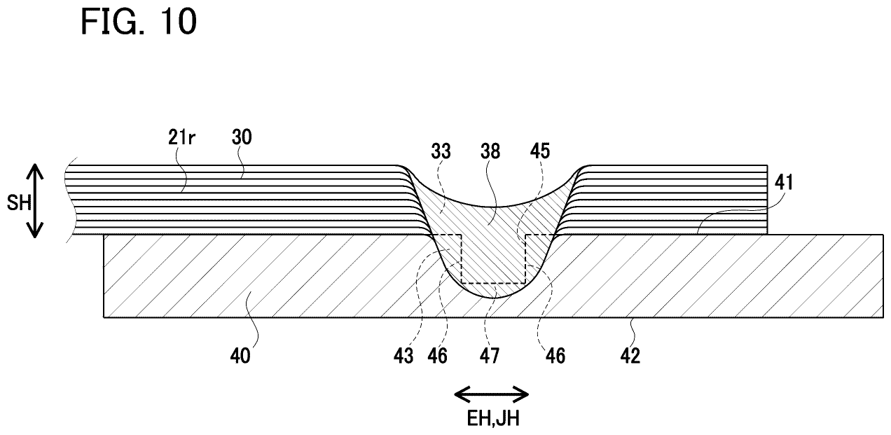

As shown in FIG. 10 showing a modified embodiment of the first embodiment, the second region 43 of the unwelded current collecting member 40Z may consist of the entire side walls 46 and the entire bottom portion 47 of the unwelded current collecting member 40Z.

In this case, as a result of formation of the melted and solidified portion 38 by laser welding, no overlapping surface side gas exhaust groove 45 is present on the rear surface 42 side of the melted and solidified portion 38 in the current collecting member 40 after laser welding. However, it is preferable to leave a part of the overlapping surface side gas exhaust groove 45 on the rear surface 42 side of the melted and solidified portion 38 as in the first embodiment described above, because the gas can be more properly exhausted to the outside through the overlapping surface side gas exhaust groove 45 during welding.

Meanwhile, in a terminal mounting step S3 (see FIG. 4), the case lid member 12 is prepared, and the positive and negative terminals 50 are fixed to the case lid member 12 (see FIG. 1 to FIG. 3). Specifically, the internal terminal member 51, external terminal member 52, crimped terminal member 53, internal insulating member 55, and external insulating member 56 of the positive electrode are prepared. Then, the internal insulating member 55 and the external insulating member 56 are placed at predetermined positions of the case lid member 12, and the internal terminal member 51, external terminal member 52, and crimped terminal member 53 are placed in position. The crimped terminal member 53 is crimped so that the terminal 50 of the positive electrode that consists of the internal terminal member 51, external terminal member 52, and crimped terminal member 53 is formed, and the terminal 50 is fixed to the case lid member 12 while being insulted therefrom. The terminal 50 of the negative electrode is also formed in the same manner as the terminal 50 of the positive electrode.

Then, in a connecting step S4 (see FIG. 4), the positive and negative current collecting members 40 connected to the electrode body 20 in the laser welding step S2 are connected to the positive and negative terminals 50 supported by the case lid member 12. Specifically, a part of the current collecting member 40 of the positive electrode is superposed on a part of the internal terminal member 51 of the terminal 50 of the positive electrode, and a laser beam is applied to the current collecting member 40 from above the current collecting member 40, so that the current collecting member 40 is laser-welded to the internal terminal member 51. Similarly, the current collecting member 40 of the negative electrode is laser-welded to the internal terminal member 51 of the negative electrode. The electrode body 20 is then wrapped with the bag-like insulating holder 7.

Then, in a case forming step S5 (see FIG. 4), the case body 11 is prepared, the electrode body 20 covered with the insulating holder 7 is inserted into the case body 11, and the opening portion 11c of the case body 11 is closed with the case lid member 12. Then, the opening portion 11c of the case body 11 and the peripheral portion 12f of the case lid member 12 are laser-welded hermetically over the entire circumference so that the case 10 is formed.

Then, in a pouring and sealing step S6, the electrolyte 5 is poured into the case 10 through the liquid inlet 10k, so that the electrode body 20 is impregnated with the electrolyte 5. Then, the liquid inlet 10k is hermetically sealed with the sealing member 15.

Then, in an initial charging and aging step S7, initial charging is performed on the battery 1. Then, the battery 1 is left to stand for a predetermined time so that the battery 1 is aged. In this manner, the battery 1 is completed.

In the method of manufacturing the battery 1 of the first embodiment, the gas exhaust channel 45 is provided in advance at least in the second region 43 of the unwelded current collecting member 40Z. Then, in the laser welding step S2, the first region 33 of the unwelded laminated current collector 30Z and the second region 43 of the unwelded current collecting member 40Z are melted, and, after the gas generated from the first and second regions 33, 43 is exhausted from the gas exhaust channel 45 to the outside, the melted and solidified portion 38 is formed. Therefore, the possibility of generation of blowholes in the melted and solidified portion 38 can be reduced or eliminated.

Furthermore, in the first embodiment, the gas exhaust channel 45 is provided in the portion on the overlapping surface 41 side of the unwelded current collecting member 40Z, and is in the form of the overlapping surface side gas exhaust groove provided at least in the second region 43. Therefore, in the laser welding step S2, the gas is properly exhausted from the overlapping surface side gas exhaust groove 45, and the melted and solidified portion 38 with no blowholes or reduced blowholes can be formed.

### Second Embodiment

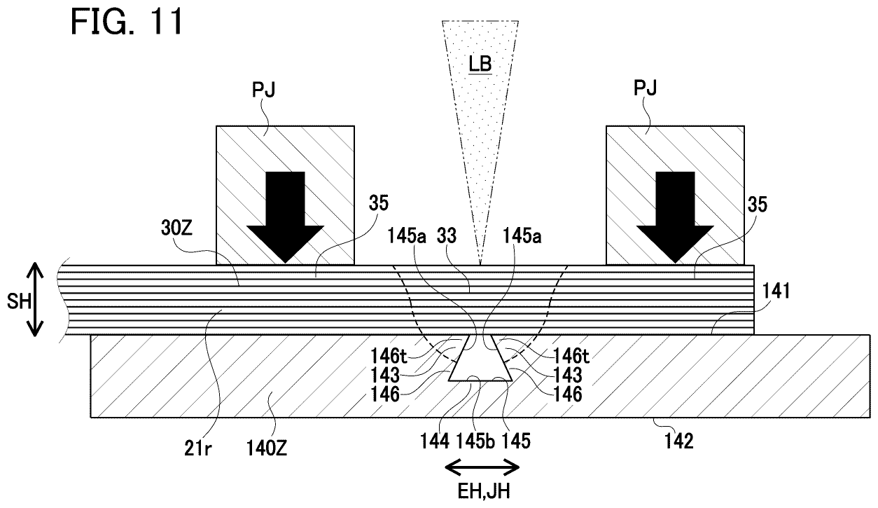

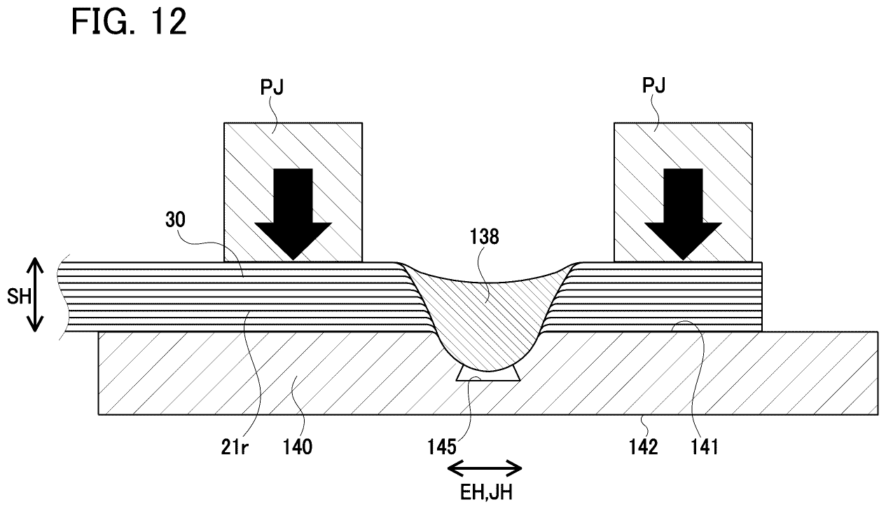

Next, the second embodiment will be described (see FIG. 11 and FIG. 12). Description of portions of the second embodiment similar to those of the first embodiment will be omitted or simplified. In the second embodiment, the configuration of an overlapping surface side gas exhaust groove (gas exhaust channel) 145 provided in advance in an unwelded current collecting member 140Z used in the manufacture of a battery 100 is different from that of the overlapping surface side gas exhaust groove 45 provided in the unwelded current collecting member 40Z according to the first embodiment.

Specifically, the unwelded current collecting member 140Z of the second embodiment also has the overlapping surface side gas exhaust groove 145 in an exhaust channel forming region 144 including a second region 143 to be melted by laser welding (see FIG. 11). The overlapping surface side gas exhaust groove 145 is provided on an overlapping surface 141 side of the unwelded current collecting member 140Z, and extends in the first direction DH. The overlapping surface side gas exhaust groove 145 has a bottom 145b parallel to the overlapping surface 141 and rear surface 142 of the unwelded current collecting member 140Z, and a pair of sides 145a extending from the bottom 145b to the overlapping surface 141. Unlike the overlapping surface side gas exhaust groove 45 of the first embodiment, the overlapping surface side gas exhaust groove 145 of the second embodiment has the shape of an inversely tapered groove of which the width increases from the overlapping surface 141 toward the bottom 145b.

In the laser welding step S2, as in the first embodiment, the unwelded laminated current collector 30Z is superposed on the overlapping surface 141 of the unwelded current collecting member 140Z in the lamination direction SH, and a pair of pressing jigs PJ is further superposed on the unwelded laminated current collector 30Z. Then, the unwelded laminated current collector 30Z is pressed against the unwelded current collecting member 140Z with the pressing jigs PJ. Then, a laser beam LB is applied to the first region 33 of the unwelded laminated current collector 30Z, to melt and mix the first region 33 and the second region 143 of the unwelded current collecting member 140Z that overlaps the first region 33, and the metal into which the first region 33 and the second region 143 are melted and mixed is then solidified to form a melted and solidified portion 138 so that the laminated current collector 30 is welded to the current collecting member 140 (see FIG. 12). In the second embodiment, too, the second region 143 of the unwelded current collecting member 140Z comprises overlapping surface side portions 146t on the overlapping surface 141 side of both side walls 146 that define both sides 145a of the overlapping surface side gas exhaust groove 145.

In the second embodiment, too, the first region 33 of the unwelded laminated current collector 30Z and the second region 143 of the unwelded current collecting member 140Z are melted, and gas generated from the first and second regions 33, 143 is properly exhausted to the outside through the overlapping surface side gas exhaust groove 145. Then, the melted metal is solidified to form the melted and solidified portion 138. Thus, the possibility of generation of blowholes in the melted and solidified portion 138 can be reduced or eliminated.

Furthermore, in the second embodiment, the overlapping surface side gas exhaust groove 145 has the shape of the inversely tapered groove, and the overlapping surface side portions 146t of the side walls 146 that define the overlapping surface side gas exhaust groove 145, as part of the unwelded current collecting member 140Z, are melted as the second region 143. Therefore, compared to the overlapping surface side gas exhaust groove 45 of the first embodiment of which the groove width does not change in the depth direction, the volume of the second region 143, and consequently, the volume of the melted and solidified portion 138, are increased, and the current collecting member 140 and the laminated current collector 30 can be more reliably welded together. In the meantime, the overlapping surface side gas exhaust groove 145 has the shape of the inversely tapered groove that is wider on the bottom 145b side; therefore, the generated gas is easily exhausted to the outside through the overlapping surface side gas exhaust groove 145, and the possibility of generation of blowholes in the melted and solidified portion 138 can be effectively reduced or eliminated. Other portions of the second embodiment similar to those of the first embodiment provide substantially the same effects in the second embodiment.

### Third Embodiment

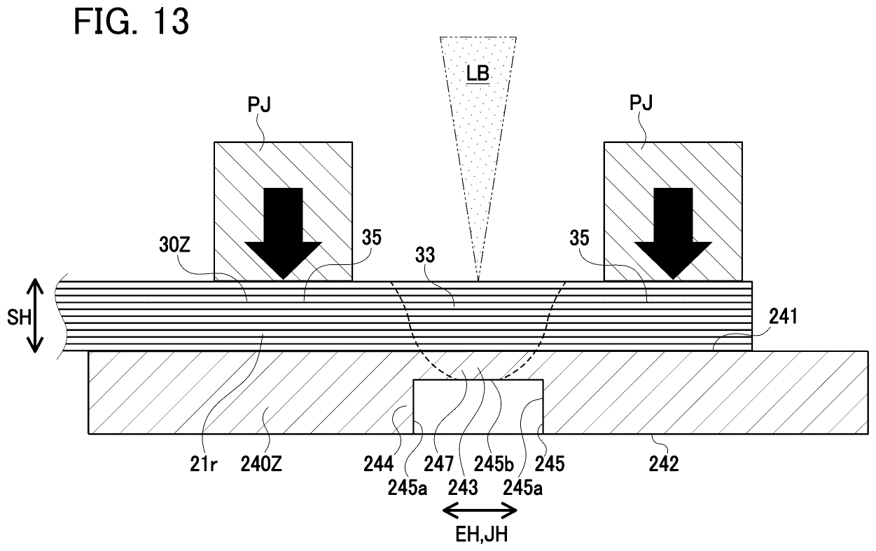

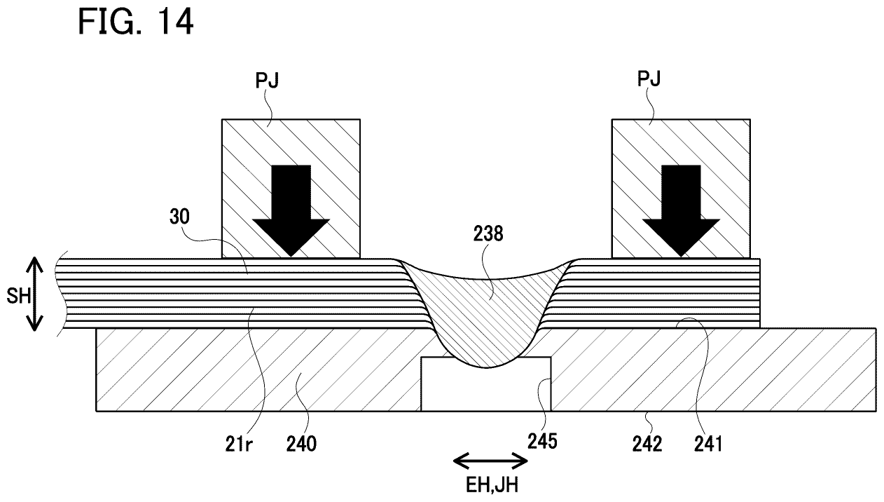

Next, the third embodiment will be described (see FIG. 13 and FIG. 14). Description of portions of the third embodiment similar to those of the first or second embodiment will be omitted or simplified. In the third embodiment, the configuration of a gas exhaust channel 245 provided in advance in an unwelded current collecting member 240Z used for the manufacture of a battery 200 is different from those of the gas exhaust channels 45, 145 provided in the unwelded current collecting members 40Z, 140Z of the first and second embodiments.

Specifically, the unwelded current collecting member 240Z of the third embodiment has a rear surface side gas exhaust groove as the gas exhaust channel 245 in an exhaust channel forming region 244 including a second region 243 to be melted by laser welding (see FIG. 13). The rear surface side gas exhaust groove 245 is provided in a rear surface 242 of the unwelded current collecting member 240Z and extends in the first direction DH. The rear surface side gas exhaust groove 245 has a bottom 245b parallel to an overlapping surface 241 and the rear surface 242, and a pair of sides 245a extending from the bottom 245b to the rear surface 242. The groove width is constant from the bottom 245b to the rear surface 242.

In the laser welding step S2, as in the first embodiment, the unwelded laminated current collector 30Z is superposed on the overlapping surface 241 of the unwelded current collecting member 240Z in the lamination direction SH, and a pair of pressing jigs PJ is further superposed on the unwelded laminated current collector 30Z to press the unwelded laminated current collector 30Z against the unwelded current collecting member 240Z with the pressing jigs PJ. Then, a laser beam LB is applied to the first region 33 of the unwelded laminated current collector 30Z to melt and mix the first region 33 and the second region 243 of the unwelded current collecting member 240Z that overlaps the first region 33. Then, the metal into which the first region 33 and the second region 243 are melted and mixed is solidified to form a melted and solidified portion 238 so that the laminated current collector 30 is welded to the current collecting member 240 (see FIG. 14). In the third embodiment, the second region 243 of the unwelded current collecting member 240Z is a middle part of a bottom portion 247 that defines the bottom 245b of the rear surface side gas exhaust groove 245, and extends over the entire thickness of the bottom portion 247.

In the third embodiment, too, the first region 33 of the unwelded laminated current collector 30Z and the second region 243 of the unwelded current collecting member 240Z are melted, and gas generated from these regions 33, 243 is exhausted to the outside through the rear surface side gas exhaust groove 245. Then, the melted metal is solidified to form the melted and solidified portion 238. Therefore, the possibility of generation of blowholes in the melted and solidified portion 238 is reduced or eliminated.

Furthermore, in the third embodiment, the gas exhaust channel 245 is the rear surface side gas exhaust groove that is provided in a portion on the rear surface 242 side of the unwelded current collecting member 240Z and provided at least in the second region 243. Therefore, in the laser welding step S2, the gas is properly exhausted from the rear surface side gas exhaust groove 245, and the melted and solidified portion 238 with no blowholes or reduced blowholes can be formed. Other portions of the third embodiment similar to those of the first or second embodiment provide substantially the same effects in the third embodiment.

### Fourth Embodiment

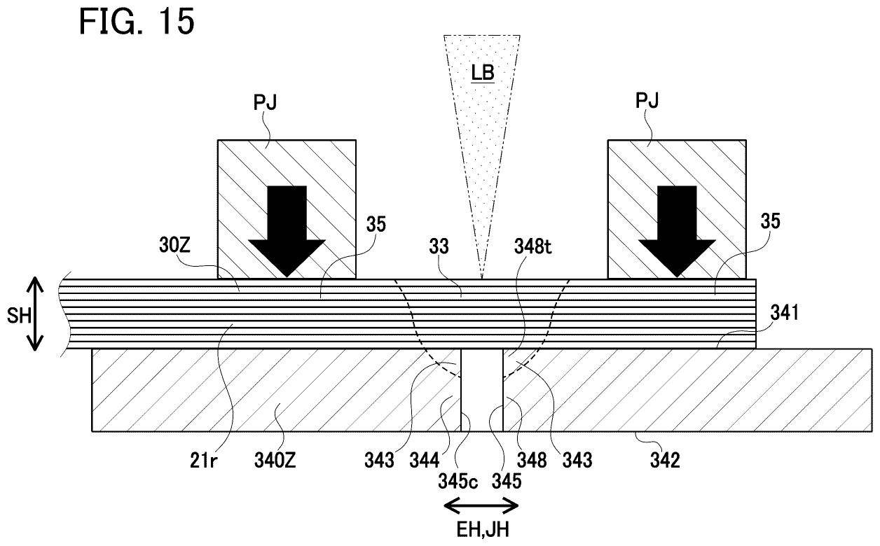

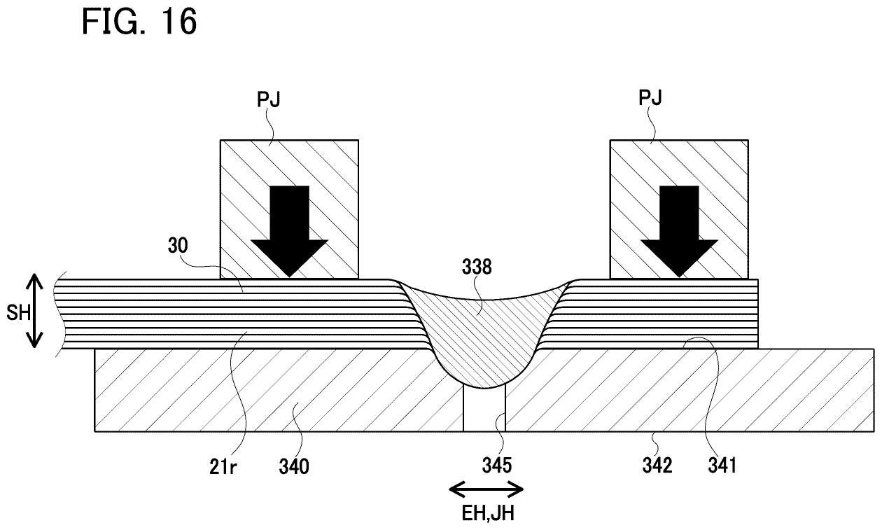

Next, the fourth embodiment will be described (see FIG. 15 and FIG. 16). Description of portions of the fourth embodiment similar to those of any of the first to third embodiments will be omitted or simplified. In the fourth embodiment, the configuration of a gas exhaust channel 345 provided in advance in an unwelded current collecting member 340Z used for the manufacture of a battery 300 is different from those of the gas exhaust channels 45, 145, 245 provided in the unwelded current collecting members 40Z, 140Z, 240Z of the first to third embodiments.

Specifically, the unwelded current collecting member 340Z of the fourth embodiment has a gas exhaust through-hole as the gas exhaust channel 345 in an exhaust channel forming region 344 including a second region 343 to be melted by laser welding (see FIG. 15). The gas exhaust through-hole 345 penetrates the unwelded current collecting member 340Z between an overlapping surface 341 and a rear surface 342, extends in the first direction DH, and has an elongated rectangular cross-section perpendicular to the depth direction of the through-hole. The dimension of the gas exhaust through-hole 345 measured in the second direction EH is constant from the overlapping surface 341 to the rear surface 342 (i.e., the dimension does not change in the depth direction), and the size (opening area) of the cross-section perpendicular to the depth direction does not change in the depth direction.

In the laser welding step S2, as in the first embodiment, the unwelded laminated current collector 30Z is superposed on the overlapping surface 341 of the unwelded current collecting member 340Z in the lamination direction SH, and a pair of pressing jigs PJ is further superposed on the unwelded laminated current collector 30Z to press the unwelded laminated current collector 30Z against the unwelded current collecting member 340Z with the pressing jigs PJ. Then, a laser beam LB is applied to the first region 33 of the unwelded laminated current collector 30Z to melt and mix the first region 33 and the second region 343 of the unwelded current collecting member 340Z that overlaps the first region 33. The metal into which the first region 33 and the second region 343 are melted and mixed is then solidified to form a melted and solidified portion 338 so that the laminated current collector 30 is welded to the current collecting member 340 (see FIG. 16). In the fourth embodiment, the second region 343 of the unwelded current collecting member 340Z is an overlapping surface side portion 348t on the overlapping surface 341 side of an inner wall 348 that defines an inner circumferential surface 345c of the gas exhaust through-hole 345.

In the fourth embodiment, too, the first region 33 of the unwelded laminated current collector 30Z and the second region 343 of the unwelded current collecting member 340Z are melted, and gas generated from the first and second regions 33, 343 is exhausted to the outside through the gas exhaust channel 345. Then, the melted metal is solidified to form the melted and solidified portion 338. Therefore, the possibility of generation of blowholes in the melted and solidified portion 338 is reduced or eliminated.

Furthermore, in the fourth embodiment, the gas exhaust channel 345 is the gas exhaust through-hole that penetrates the unwelded current collecting member 340Z and is provided at least in the second region 343. Therefore, in the laser welding step S2, the gas is properly exhausted from the gas exhaust through-hole 345, and the melted and solidified portion 338 with no blowholes or reduced blowholes can be formed. Other portions of the fourth embodiment similar to those of any of the first to third embodiments provide substantially the same effects in the fourth embodiment.

### Fifth Embodiment

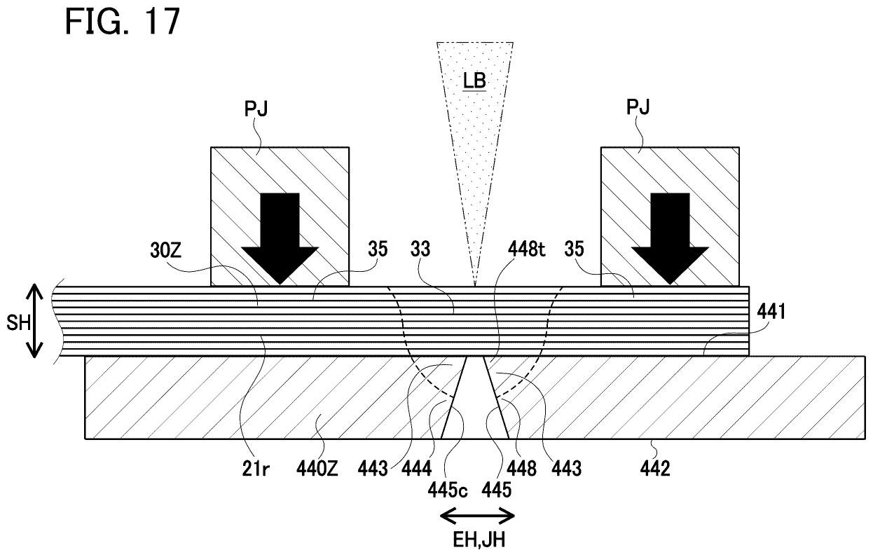

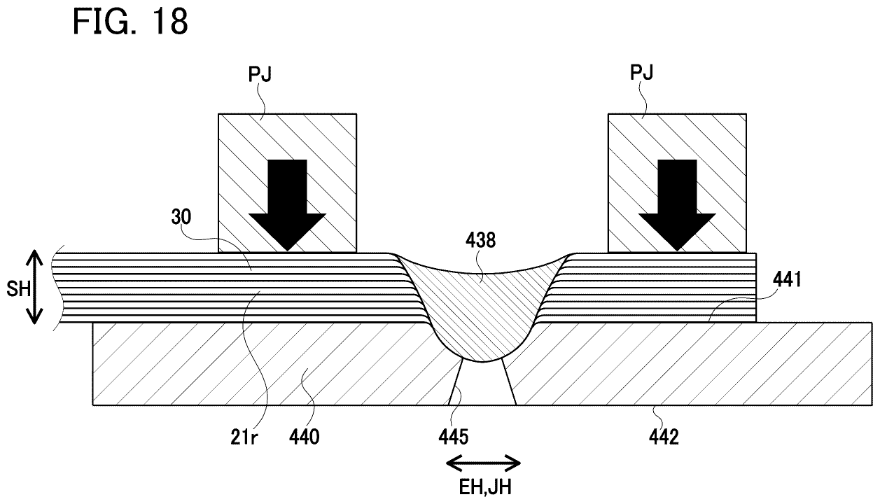

Next, the fifth embodiment will be described (see FIG. 17 and FIG. 18). Description of portions of the fifth embodiment similar to those of any of the first to fourth embodiments will be omitted or simplified. In the fifth embodiment, the configuration of a gas exhaust through-hole (gas exhaust channel) 445 provided in advance in an unwelded current collecting member 440Z used for the manufacture of a battery 400 is different from that of the gas exhaust through-hole 345 provided in the unwelded current collecting member 340Z of the fourth embodiment.

Specifically, the unwelded current collecting member 440Z of the fifth embodiment has the gas exhaust through-hole 445 in an exhaust channel forming region 444 including a second region 443 to be melted by laser welding (see FIG. 17). The gas exhaust through-hole 445 penetrates the unwelded current collecting member 440Z between an overlapping surface 441 and a rear surface 442 and extends in the first direction DH. Unlike the gas exhaust through-hole 345 of the fourth embodiment, the gas exhaust through-hole 445 of the fifth embodiment has an inversely tapered shape in which its size increases from the overlapping surface 441 to the rear surface 442 (i.e., the area of the opening perpendicular to the depth direction increases toward the rear surface 442), more specifically, the dimension measured in the second direction EH increases toward the rear surface 442.

In the laser welding step S2, as in the first embodiment, the unwelded laminated current collector 30Z is superposed on the overlapping surface 441 of the unwelded current collecting member 440Z in the lamination direction SH, and a pair of pressing jigs PJ is further superposed on the unwelded laminated current collector 30Z to press the unwelded laminated current collector 30Z against the unwelded current collecting member 440Z with the pressing jigs PJ. Then, a laser beam LB is applied to the first region 33 of the unwelded laminated current collector 30Z to melt and mix the first region 33 and the second region 443 of the unwelded current collecting member 440Z that overlaps the first region 33. Then, the metal into which the first region 33 and the second region 443 are melted and mixed is solidified to form a melted and solidified portion 438 so that the laminated current collector 30 is welded to the current collecting member 440 (see FIG. 18). In the fifth embodiment, too, the second region 443 of the unwelded current collecting member 440Z is an overlapping surface side portion 448t on the overlapping surface 441 side of an inner wall 448 that defines an inner circumferential surface 445c of the gas exhaust through-hole 445.

In the fifth embodiment, too, the first region 33 of the unwelded laminated current collector 30Z and the second region 443 of the unwelded current collecting member 440Z are melted, and gas generated from the first and second regions 33, 443 is exhausted to the outside through the gas exhaust through-hole 445. Then, the melted metal is solidified to form the melted and solidified portion 438. Therefore, the possibility of generation of blowholes in the melted and solidified portion 438 can be reduced or eliminated.

Furthermore, in the fifth embodiment, the gas exhaust through-hole 445 has the inversely tapered shape that is wider on the rear surface 442 side, and the overlapping surface side portion 448t of the inner wall 448 that defines the gas exhaust through-hole 445, as part of the unwelded current collecting member 440Z, is melted as the second region 443. Therefore, compared to the gas exhaust through-hole 345 of the fourth embodiment of which the dimension does not change in the depth direction, the volume of the second region 443, and consequently, the volume of the melted and solidified portion 438, are increased, and the current collecting member 440 and the laminated current collector 30 can be more reliably welded together. In the meantime, since the gas exhaust through-hole 445 has the inversely tapered shape that is wider on the rear surface 442 side, the generated gas is easily exhausted to the outside through the gas exhaust through-hole 445, and the possibility of generation of blowholes in the melted and solidified portion 438 can be effectively reduced or eliminated. Other portions of the fifth embodiment similar to those of any of the first to fourth embodiments provide substantially the same effects in the fifth embodiment.

### Sixth Embodiment

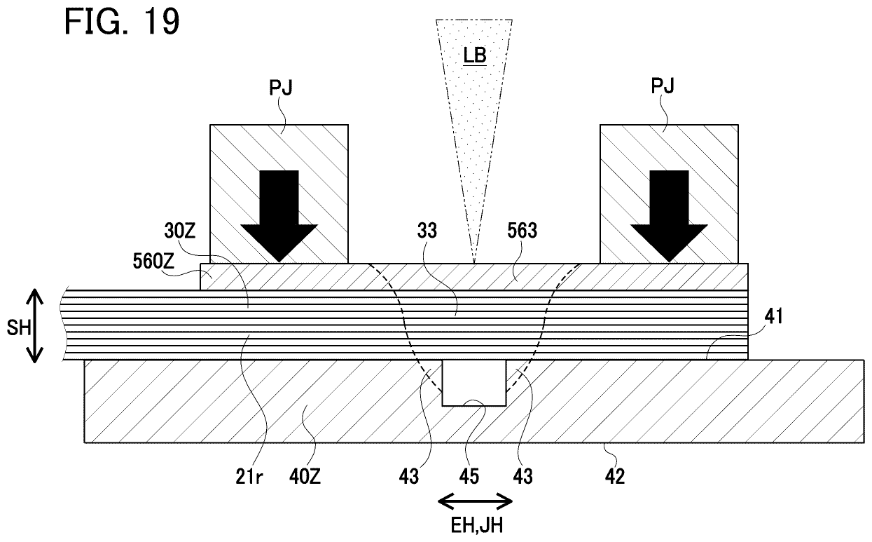

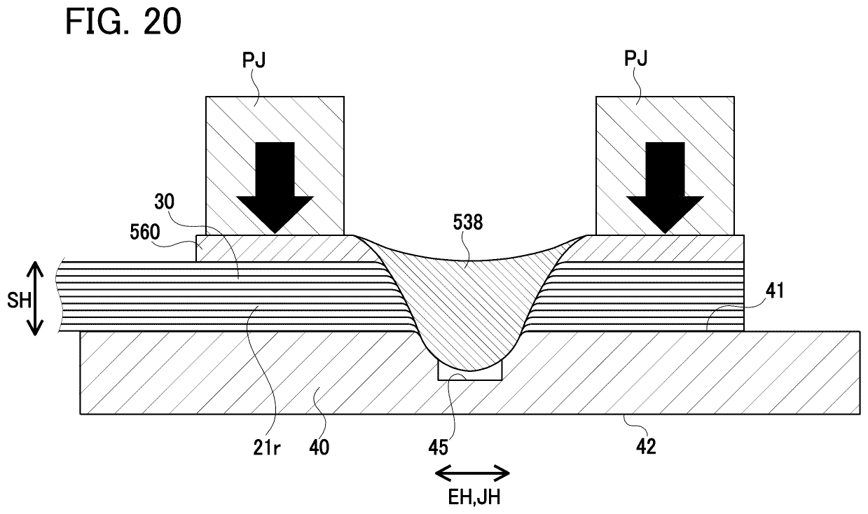

Next, the sixth embodiment will be described (see FIG. 19 and FIG. 20). Description of portions of the sixth embodiment similar to those of any of the first to fifth embodiments will be omitted or simplified. A battery 500 of the sixth embodiment is different from the battery 1 of the first embodiment in that the battery 500 further includes a metal member 560 that cooperates with the current collecting member 40 to sandwich the laminated current collector 30 of the electrode body 20 and is welded to the laminated current collector 30 and the current collecting member 40 (see FIG. 20).

Specifically, the metal member 560 is in the form of a rectangular plate extending in the battery width direction BH and the battery thickness direction CH. The metal member 560 of the positive electrode is made of aluminum and the metal member 560 of the negative electrode is made of copper.

In the laser welding step S2, the unwelded laminated current collector 30Z is superposed on the overlapping surface 41 of the unwelded current collecting member 40Z in the lamination direction SH, an unwelded metal member 560Z that has not been welded is superposed on the unwelded laminated current collector 30Z, and a pair of pressing jigs PJ is further superposed on the unwelded metal member 560Z (see FIG. 19). Then, the unwelded metal member 560Z is pressed with the pressing jigs PJ to press the unwelded laminated current collector 30Z against the unwelded current collecting member 40Z. Then, a laser beam LB is applied to the unwelded metal member 560Z to melt and mix a third region 563 of the unwelded metal member 560Z, the first region 33 of the unwelded laminated current collector 30Z, and the second region 43 of the unwelded current collecting member 40Z, and the metal into which the first region 33, second region 43, and third region 563 are melted and mixed is then solidified to form a melted and solidified portion 538 (see FIG. 20). In this manner, the metal member 560, laminated current collector 30, and current collecting member 40 are welded together.

In the laser welding step S2, the third region 563 of the unwelded metal member 560Z, the first region 33 of the unwelded laminated current collector 30Z, and the second region 43 of the unwelded current collecting member 40Z are melted, and gas generated from the first, second, and third regions 33, 43, 563 are properly exhausted to the outside through the overlapping surface side gas exhaust groove 45. Then, the melted metal is solidified to form a melted and solidified portion 538. Therefore, the possibility of generation of blowholes in the melted and solidified portion 538 can be reduced or eliminated. Other portions of the sixth embodiment similar to those of any of the first to fifth embodiments provide substantially the same effects in the sixth embodiment.

While the disclosure has been described in the light of the first to sixth embodiments, it is to be understood that the disclosure is not limited to the first to sixth embodiments, but may be applied by making changes as needed, without departing from the principle of the disclosure.

In the first to sixth embodiments, the battery 1, etc. including a single electrode body 20 is illustrated by way of example. However, the battery is not limited to this type, but may include two or more electrode bodies. In this case, two or more pairs of positive and negative current collecting members may be prepared, and positive and negative laminated current collectors may be welded to the positive and negative current collecting members for each electrode body. Alternatively, one positive current collecting member and one negative current collecting member may be prepared, and two or more laminated current collectors of the positive electrode may be welded to the one current collecting member of the positive electrode, while two or more laminated current collectors of the negative electrode may be welded to the one current collecting member of the negative electrode.

In the first to sixth embodiments, the laminate-type electrode body is illustrated by way of example as the electrode body. However, the electrode body is not limited to this type, but may be of a flat wound type in which positive and negative strip-shaped electrode sheets are wound into a flat shape via a pair of strip-shaped separators.

In the first to sixth embodiments, the laser welding step S2 is carried out using the YAG laser. However, the laser is not limited to this type, and a fiber laser, disk laser, blue laser, green laser, etc. may be used as appropriate.

In the first to sixth embodiments, the battery 1, etc. is illustrated by way of example in which the current collecting member 40, etc. of the positive electrode is connected to the terminal 50 of the positive electrode of the battery 1, etc., and the current collecting member 40, etc. of the negative electrode is connected to the terminal 50 of the negative electrode of the battery 1, etc. However, the battery is not limited to this type. For example, the current collecting member of the positive electrode itself may extend to the outside of the battery and provides a positive terminal of the battery, and the current collecting member of the negative electrode itself may extend to the outside of the battery and provides a negative terminal of the battery.

### REFERENCE SIGNS LIST

1, 100, 200, 300, 400, 500 Battery (Power storage device)
10 Case
20 Electrode body
21 Electrode sheet
21r Foil current collector
22 Electrode foil
30 Laminated current collector
30Z Unwelded laminated current collector
33 First region
38, 138, 238, 338, 438, 538 Melted and solidified portion
40, 140, 240, 340, 440 Current collecting member
40Z, 140Z, 240Z, 340Z, 440Z Unwelded current collecting member
41, 141, 241, 341, 441 Overlapping surface
42, 142, 242, 342, 442 Rear surface
43, 143, 243, 343, 443 Second region
45, 145 Overlapping surface side gas exhaust groove (Gas exhaust channel)
245 Rear surface side gas exhaust groove (Gas exhaust channel)
345, 445 Gas exhaust through-hole (Gas exhaust channel)
45b, 145b, 245b Bottom
46, 146 Side wall
46t, 146t Overlapping surface side portion (of side wall)
348, 448 Inner wall
348t, 448t Overlapping surface side portion (of inner wall)
50 Terminal
SH Lamination direction (of laminated current collector)
PJ Pressing jig
S2 Laser welding step

What is claimed is:

1. A method of manufacturing a power storage device including an electrode body having an electrode sheet including an electrode foil, the electrode body having a laminated current collector in which foil current collectors where the electrode foil of the electrode sheet is exposed are laminated in a lamination direction, the power storage device further including a current collecting member to which the laminated current collector of the electrode body is welded and which is conductively connected to the laminated current collector, the method comprising laser welding including
superposing an unwelded laminated current collector before welding on an unwelded current collecting member before welding in the lamination direction, and
melting and mixing a first region of the unwelded laminated current collector and a second region of the unwelded current collecting member that overlaps the first region through irradiation with a laser beam, and then solidifying a metal into which the first region and the second region are melted and mixed to form a melted and solidified portion and weld the laminated current collector to the current collecting member,
wherein the unwelded current collecting member has a gas exhaust channel at least in the second region, and
wherein the laser welding includes melting the first region and the second region while exhausting gas generated from the first region and the second region to an outside through the gas exhaust channel, and then forming the melted and solidified portion.

2. The method of manufacturing the power storage device according to claim 1, wherein:
the unwelded current collecting member has an overlapping surface on which the unwelded laminated current collector is superposed; and
the gas exhaust channel is an overlapping surface side gas exhaust groove provided in the overlapping surface of the unwelded current collecting member and provided at least in the second region.

3. The method of manufacturing the power storage device according to claim 2, wherein:
the overlapping surface side gas exhaust groove has a shape of an inversely tapered groove of which the width increases from the overlapping surface of the unwelded current collecting member toward a bottom of the overlapping surface side gas exhaust groove; and
the second region of the unwelded current collecting member includes at least overlapping surface side portions on the overlapping surface side of a pair of side walls that defines the overlapping surface side gas exhaust groove.

4. The method of manufacturing the power storage device according to claim 1, wherein:
the unwelded current collecting member has an overlapping surface on which the unwelded laminated current collector is superposed, and a rear surface located opposite to the overlapping surface; and
the gas exhaust channel is a rear surface side gas exhaust groove provided in the rear surface of the unwelded current collecting member and provided at least in the second region.

5. The method of manufacturing the power storage device according to claim 1, wherein:
the unwelded current collecting member has an overlapping surface on which the unwelded laminated current collector is superposed, and a rear surface located opposite to the overlapping surface; and
the gas exhaust channel is a gas exhaust through-hole that penetrates the unwelded current collecting member between the overlapping surface and the rear surface and is provided at least in the second region.

6. The method of manufacturing the power storage device according to claim 5, wherein:
the gas exhaust through-hole has an inversely tapered shape in which a size increases from the overlapping surface of the unwelded current collecting member toward the rear surface; and
the second region of the unwelded current collecting member includes at least an overlapping surface side portion on the overlapping surface side of an inner wall that defines the gas exhaust through-hole.
